(19) United States
(12) Patent Application Publication
(10) Pub. No.: US 2012/0269710 A1
(43) Pub. Date: Oct. 25, 2012

(54) Thermal oxidation system and method for preventing water from accumulation

(76) Inventor: Chunlong Li, Beijing (CN)

(21) Appl. No.: 13/380,930

(22) PCT Filed: Aug. 9, 2011
(86) PCT No.: PCT/CN11/01316

§ 371 Date: Dec. 27, 2011

(30) Foreign Application Priority Data
Apr. 25, 2011 (CN) 201110109430.3

(51) Int. Cl. C01B 33/12; B01J 19/00

(52) U.S. Cl. 423/335; 422/162

(57) ABSTRACT

The invention proposes a thermal oxidation system, which comprises: a reaction furnace for preparing silicon oxide by wet oxidation; a vapor generating chamber, feed gases reacting in the vapor generating chamber to generate water vapor and the generated water vapor entering the reaction furnace through the delivery of a pipeline; a feed gas inlet pipeline for providing the feed gases to the vapor generating chamber; a carrier gas inlet pipeline for providing the carrier gas to the reaction furnace; and a heater coupled to the feed gas inlet pipeline for heating the feed gases to promote their reaction to generate water vapor; characterized in that, the thermal oxidation system further comprises a heating device coupled to the carrier gas inlet pipeline. In the thermal oxidation system and method according to the invention, since the carrier gas is heated, liquid water is avoided to remain in the gas inlet pipeline, which controls the quality in growth of the film, and improves the reliability of the semiconductor device.

This application is a National Phase application of, and claims priority to, PCT Application No. PCT/CN2011/001316, filed on Aug. 9, 2011, entitled “Thermal oxidation system and method for preventing water from accumulation”, which claimed priority to Chinese Application No. 201110109430.3, filed on Apr. 25, 2011. Both the PCT Application and Chinese Application are incorporated herein by reference in their entireties.

### FIELD OF THE INVENTION

The invention relates to a method for manufacturing a semiconductor device, particularly to a thermal oxidation system and method for preventing water from accumulating in a reaction system used for heating in a semiconductor process.

### BACKGROUND OF THE INVENTION

An insulating material with a good insulating property and chemical stability is usually required to be used in a semiconductor device and its corresponding process, in particular an electrically insulating material capable of being tightly bonded to a substrate of for example silicon and with little interface defect. Due to possessing good properties described above, silicon dioxide is widely applied in the gate oxide layer, the device protecting layer, the electrically isolating layer, the etching stopping layer, the anti-diffusion layer, the liner layer, the interlayer insulating layer and the capacitance dielectric film, etc. of MOSFETs.

There are numerous methods for preparing SiO₂, including thermal decomposition deposition, sputtering, vacuum evaporation, anode oxidation, CVD, thermal oxidation method, etc., wherein the preparation of SiO₂ by the thermal oxidation method has a very high repeatability and chemical stability, is capable of reducing silicon surface dangling bonds so as to decrease the surface state density and can also well control the interface traps and fixed charges, therefore becoming the main technical means or process for preparing SiO₂.

The preparation of SiO₂ by the thermal oxidation method makes use of the fact that silicon reacts chemically with oxidant containing an oxygen element at high temperatures to generate silicon oxide. The thermal oxidation method using pure oxygen is referred to as dry oxygen oxidation, and its product structure is compact, dry, and with a good uniformity and repeatability. Usually, a silicon oxide film of high quality substantially makes use of such a process. However, the growth rate of the dry oxygen oxidation is low, and although it is applicable for a thin layer of gate oxide layer, it does not seem economical and practical for a thicker interlayer oxide layer or isolating film.

The current method for preparing SiO₂ of a thick film is to employ the wet oxidation, illustrated in FIG. 1A being a prior oxidation system for preparing SiO₂ by the wet oxidation. A reaction furnace 1 has a gas inlet 2 for a reactive gas (other components like a furnace door, a furnace body heating device, etc. are not shown), the gas inlet 2 is connected with a vapor generating chamber 5 by a pipeline 3, the pipeline 3 is further connected with a gas inlet pipeline 6 for a carrier gas or a diluent gas by a three-way valve 4 thereon, the gas inlet pipeline 6 is connected to an external gasholder or an external pipeline (not shown) for delivering an inert gas, generally N₂ or Ar, and the vapor generating chamber 5 is connected to a gas inlet pipeline 7 for a feed gas, wherein the gas inlet pipeline 7 has a manifold 8 for inputting pure O₂ and pure H₂ from the external gasholder or the external pipeline (not shown) respectively, on the gas inlet pipeline 7 is also coupled (connected, surrounding, or set nearby) a heater 9, and the heater 9 takes the form of a non-burning heater such as resistance-, electromagnetic coil-typed heater, etc. Heating is performed outside the gas inlet pipeline 7 to about 700° C., so that pure O₂ and pure H₂ at high temperature react chemically in the vapor generating chamber 5 to generate water vapor, the generated water vapor enters the reaction furnace 1 through the pipeline 3 under the promotion and drive of the inert gas in the gas inlet pipeline 6 for a carrier gas, in which reaction furnace 1 the water vapor H₂O reacts with Si in a wafer to generate SiO₂ and H₂ (Si+H₂O——>SiO₂+H₂). In such an oxidation system, the pressure of the water vapor H₂O as an oxidant may be adjusted by the pressure, flow rate, etc. of the inputted pure oxygen and pure hydrogen. Furthermore, the presence of an inert gas (e.g., N₂) as a carrier gas may also slow the reaction rate of silicon oxide, thereby controlling the film quality.

However, the carrier gas is usually loaded using a commercially available gas tank or a delivery pipeline, and the temperature of the carrier gas is usually the same as or close to the room temperature, which is about 23° C. During the operation of the whole oxidation system, the carrier gas at a low temperature and the water vapor at a high temperature meet at the valve 4 and share a piece of pipeline 3 until they enter the reaction furnace 1, when part of the high-temperature water vapor will be condensed into liquid water under the cooling of the low-temperature carrier gas, and aggregates between the valve 4 and the gas inlet 2. What is shown in FIG. 1B is a partially enlarged drawing of FIG. 1A, wherein the shaded part represents the liquid water. The water vapor is condensed before entering a cavity of a furnace tube, causing the amount of the water vapor at the main oxidation step to be reduced. This is equivalent to a reduction of the gas flow of H₂ and O₂ in a recipe. This certainly will change the quality and thickness of the film of SiO₂, which is undesired to happen for the semiconductor industry with a very high requirement for the thermal oxidation of SiO₂. In addition, the aggregation of the liquid water at a part of the pipeline 3 between the valve 4 and the gas inlet 2 over a long period of time will cause the corrosion of the pipeline 3, and after the corrosion perforation, the external air or impurities will enter the pipeline and be brought into the reaction furnace, and pollute the furnace environment, which will result in a serious deterioration in the quality of the wafer, and even discard of all the products. In summary, there are the above-mentioned drawbacks in the prior thermal oxidation system, and there is a need for improving the thermal oxidation system to avoid accumulation of liquid water in the reaction system.

### SUMMARY OF THE INVENTION

In view of the above, an object of the invention is to provide an improved thermal oxidation system and its corresponding method to avoid accumulation of liquid water in the reaction furnace.

The invention proposes a thermal oxidation system, which comprises: a reaction furnace for preparing silicon oxide by wet oxidation; a vapor generating chamber, feed gases reacting in the vapor generating chamber to generate water vapor and the generated water vapor entering the reaction furnace through the delivery of a pipeline; a feed gas inlet pipeline for providing the feed gases to the vapor generating chamber; a carrier gas inlet pipeline for providing the carrier gas to the reaction furnace; and a heater coupled to the feed gas inlet pipeline for heating the feed gases to promote their reaction to generate water vapor; characterized in that, the thermal oxidation system further comprises a heating device coupled to the carrier gas inlet pipeline.

The invention also proposes a thermal oxidation method for preparing silicon oxide by wet oxidation, which comprises: delivering a carrier gas into a reaction furnace; delivering heated feed gases into a vapor generating chamber, the feed gases reacting to generate high-temperature water vapor; heating the carrier gas; delivering the feed gases and the carrier gas into the reaction furnace simultaneously.

Wherein, the feed gases are oxygen and hydrogen. Wherein the heater heats the feed gases to 700° C. Wherein the heating device is the heater. Wherein the heating device is a heat exchange mechanism constituted by the feed gas inlet pipeline and the carrier gas inlet pipeline. Wherein, the heater is a non-burning heater. Wherein the carrier gas is nitrogen. Wherein the heating device heats the carrier gas to more than 100° C.

In the thermal oxidation system and method according to the invention, since the carrier gas is heated, liquid water is avoided to remain in the gas inlet pipeline, which prevents the liquid water from being brought into the reaction furnace, controls the quality in growth of the film, and improves the reliability of the semiconductor device.

### BRIEF DESCRIPTION OF THE DRAWINGS

The technical solutions of the invention will be described in detail hereinafter with reference to the accompanying drawings, in which:

FIG. 1A is a schematic view of a prior thermal oxidation system;

FIG. 1B is a partially enlarged view of the prior thermal oxidation system;

FIG. 2A is a schematic view of a thermal oxidation system according to the invention; and

FIG. 2B is a partially enlarged view of the thermal oxidation system according to the invention.

### DETAILED DESCRIPTION OF THE INVENTION

In the following, the features of the technical solutions of the invention and the technical effects thereof will be described in detail with reference to the accompanying drawings and in connection with schematic embodiments. An improved thermal oxidation system and method therefore are disclosed to avoid accumulation of liquid water in a reaction furnace. It should be noted that like reference numbers denote like structures, and the terms “first”, “second”, “above” and “below”, etc. used in this application may be used for describing various system components and manufacturing processes. Such description does not suggest any spatial, order or hierarchical relationship, unless specifically stated.

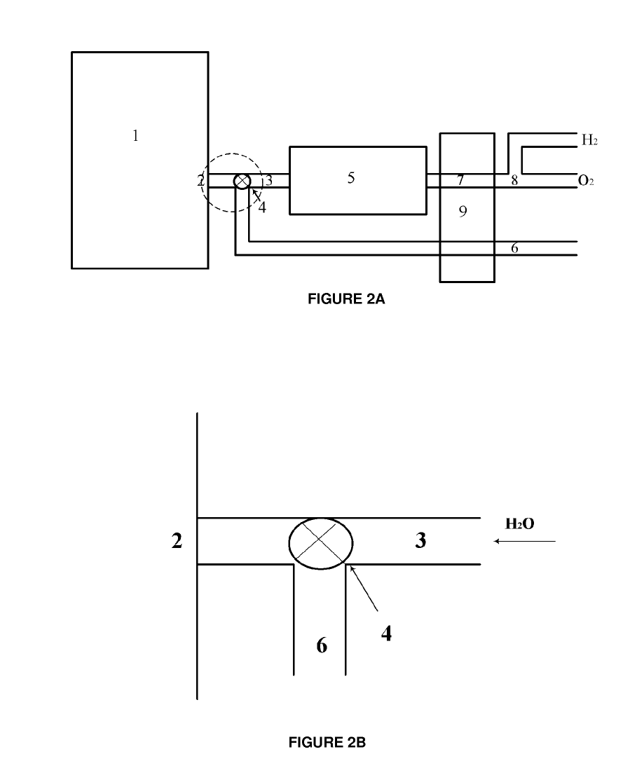

Illustrated in FIG. 2A is a thermal oxidation system for preparing SiO₂ by the wet oxidation according to the invention. A reaction furnace 1 has a gas inlet 2 for a reactive gas (other components like a furnace door, a furnace body heating device, etc. are not shown), the gas inlet 2 is connected with a vapor generating chamber 5 by a pipeline 3, the pipeline 3 is further connected with a gas inlet pipeline 6 for a carrier gas or a diluent gas by a valve 4 such as a three-way valve thereon, the gas inlet pipeline 6 is connected to an external gasholder or an external pipeline (not shown) for delivering an inert gas, generally N₂ or Ar, and the vapor generating chamber 5 is connected to a feed gas inlet pipeline 7, wherein the gas inlet pipeline 7 has a manifold 8 for inputting pure O₂ and pure H₂ from the external gasholder or the external pipeline (not shown) respectively, on the gas inlet pipeline 7 is also coupled (connected, surrounding, or set nearby) a heater 9, and the heater 9 (taking the form of a non-burning heater such as resistance-, electromagnetic coil-typed heater, etc.) performs heating outside the gas inlet pipeline 7 to about 700° C., so that pure O₂ and pure H₂ at high temperature react chemically in the vapor generating chamber 5 to generate water vapor, the generated water vapor enters the reaction furnace 1 through the pipeline 3 under the promotion and drive of the inert gas in the carrier gas inlet pipeline 6, in which reaction furnace 1 the water vapor H₂O reacts with Si in a wafer to generate SiO₂ and H₂ (Si+H₂O——>SiO₂+H₂). In such an oxidation system, the pressure of the water vapor H₂O as an oxidant can be adjusted by the pressure, flow rate, etc. of the inputted pure oxygen and pure hydrogen. Furthermore, the presence of an inert gas (e.g., N₂) as a carrier gas can also slow the reaction rate of silicon oxide, thereby controlling the film quality.

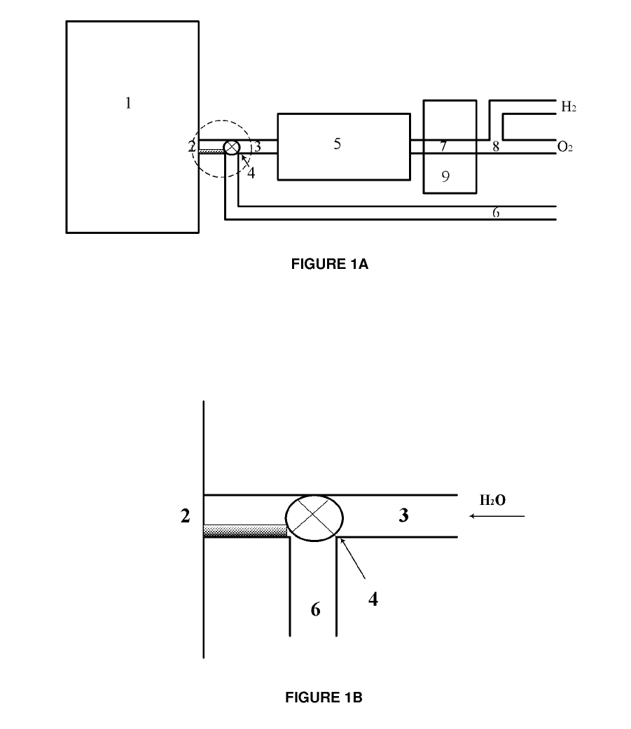

Unlike the system shown in FIG. 1A, in the thermal oxidation system according to the invention shown in FIG. 2A, the heater 9 is not only thermally coupled to the feed gas inlet pipeline 7, but also thermally coupled to the gas inlet pipeline 6 for a carrier gas or a diluent gas, namely, the heater 9 heats the pure oxygen and the pure hydrogen as a feed gas and the inert gas as a carrier gas in the pipelines simultaneously outside the gas inlet pipeline 6, which ensures that the carrier gas will not cool the feed gases at the pipeline 3 to form liquid water. Preferably, the heater 9 heats the gas inlet pipeline 6 to more than about 100° C., i.e., more than the water boiling point, thereby ensuring that the liquid water will not remain. In addition, the temperature at which the carrier gas is heated may also be for example 60° C., 70° C., 80° C., 95° C., etc., as long as the cooling effect of the carrier gas on the feed gases is not enough to let the liquid water remain in the pipeline 3. The disposition of the heater 9 between the gas inlet pipelines 6 and 7 is determined according to the layout of the gas inlet pipelines and the heating requirement, for example, the heater 9 is closer to the gas inlet pipeline 7 in order to provide more heat to ensure the vapor generating reaction but is far away from the gas inlet pipeline 6. In particular, the gas inlet pipeline 6 may surround the heater 9 and utilize the residual heat and thermal radiation to heat an inert gas as the carrier gas to make full use of heat energy.

In addition, the gas inlet pipeline 6 may also be heated by employing other heating devices or heating methods. For example, a separate second heater (not shown) is employed to heat the gas inlet pipeline 6 separately to more than 100° C. It is also possible to use only one heater 9, by forming a heat exchange mechanism in which the gas inlet pipeline 7 surrounds the gas inlet pipeline 6, or the gas inlet pipeline 6 passes through or surrounds the vapor generating chamber 5, so that water vapor at about 700° C. can be used for heating the carrier gas to more than 100° C., thereby making the most of heat energy.

The meaning of the above-mentioned “thermally coupled” is not completely limited to a direct contact between the heater or heating device and the component to be heated, it further comprises ways to deliver heat energy in a manner of heat exchange or thermal radiation in case of a distance therebetween, or can further comprise an indirect heating by applying a high frequency electromagnetic wave to a component to be heated to cause it to create an eddy heating.

Illustrated in FIG. 2B is a partially enlarged schematic view of the pipeline 3 from the valve 4 to the gas inlet 2 of the reaction furnace 1, wherein unlike the prior art shown in FIG. 1B, due to the extra heating for the gas inlet pipeline 6, there remains no liquid water in the pipeline 3 any more, and the problem of pollution due to the liquid water being brought into the reaction furnace by the carrier gas does not occur any more.

In addition, the hydrogen generated after the chemical reaction in the reaction furnace 1 may also be utilized repeatedly. For example, the hydrogen in the reaction furnace 1 is drawn out, purified and dried, and re-added to the manifold 8 to achieve the recycling of the pure hydrogen, thereby saving the cost.

The structure of the thermal oxidation system according to the invention has been described above. A method of using the said thermal oxidation system is particularly as follows.

Firstly, an inert gas such as nitrogen, argon, helium, etc. is delivered into a reaction furnace 1 through a carrier gas inlet pipeline 6, a valve 4, a pipeline 3, and a gas inlet 2 sequentially for controlling and keeping the pressure in the reaction furnace 1.

Secondly, a heater 9 is turned on to heat feed gases including pure oxygen and pure hydrogen through a manifold 8 and a feed gas inlet pipeline 7 to a high temperature, for example, about 700° C. At the same time, the inert gas in the carrier gas inlet pipeline 6 is also heated by the heater 9 or other heating mechanisms described above, to cause the temperature of the inert gas to be more than the water boiling point, namely, more than 100° C.

Then, the feed gases are fed into a vapor generating chamber 5 to react to generate high-temperature water vapor.

Next, the valve 4 is opened to deliver the feed gases and the carrier gas into the reaction furnace simultaneously, and the feed gases react with silicon on a wafer in the reaction furnace, generating a silicon dioxide film by thermal oxidation.

In the thermal oxidation system and method according to the invention, since the carrier gas is heated, liquid water is avoided to remain in the gas inlet pipeline, which prevents the liquid water from being brought into the reaction furnace, controls the quality in growth of the film, and improves the reliability of the semiconductor device.

While the invention has been described with reference to one or more exemplary embodiment, it will be understood by the skilled in the art that various suitable changes and the equivalent thereof may be made to the heating system or method without departing from the scope of the invention. Furthermore, from the disclosed teachings many modifications suitable for particular situations or materials may be made without departing from the scope of the invention. Therefore, the aim of the invention is not intended to be limited to the particular embodiments disclosed as the best implementations for implementing the invention. The disclosed heating system or method will comprise all the embodiments falling into the scope of the invention.

1. A thermal oxidation system comprising:
a reaction furnace for preparing silicon oxide by wet oxidation;
a vapor generating chamber, feed gases reacting in the vapor generating chamber to generate water vapor and the generated water vapor entering the reaction furnace through the delivery of a pipeline;
a feed gas inlet pipeline for providing the feed gases to the vapor generating chamber;
a carrier gas inlet pipeline for providing the carrier gas to the reaction furnace; and
a heater coupled to the feed gas inlet pipeline for heating the feed gases to promote their reaction to generate water vapor;
characterized in that, the thermal oxidation system further comprises a heating device coupled to the carrier gas inlet pipeline.

2. The thermal oxidation system as claimed in claim 1, wherein the feed gases are oxygen and hydrogen.

3. The thermal oxidation system as claimed in claim 1, wherein the heater heats the feed gases to 700° C.

4. The thermal oxidation system as claimed in claim 1, wherein the heating device is the heater.

5. The thermal oxidation system as claimed in claim 1, wherein the heating device is a heat exchange mechanism constituted by the feed gas inlet pipeline and the carrier gas inlet pipeline.

6. The thermal oxidation system as claimed in claim 1, wherein the heater is a non-burning heater.

7. The thermal oxidation system as claimed in claim 1, wherein the carrier gas is nitrogen.

8. The thermal oxidation system as claimed in claim 1, wherein the heating device heats the carrier gas to more than 100° C.

9. A thermal oxidation method for preparing silicon oxide by wet oxidation, comprising:
delivering a carrier gas into a reaction furnace;
delivering heated feed gases into a vapor generating chamber, the feed gases reacting to generate high-temperature water vapor;
heating the carrier gas; and
delivering the feed gases and the carrier gas into the reaction furnace simultaneously.

10. The method as claimed in claim 9, wherein the carrier gas is heated to more than 100° C.
